(19) United States
(12) Patent Application Publication
(10) Pub. No.: US 2023/0350190 A1
(43) Pub. Date: Nov. 2, 2023

(54) LIGHT SOURCE SYSTEM, UNIT, AND LASER APPARATUS

(71) Applicant: SONY GROUP CORPORATION, Tokyo (JP)

(72) Inventors: Kentarou SAKAI, Tokyo (JP); Taichi TAKEUCHI, Tokyo (JP); Yasuyuki ISHIHAMA, Tokyo (JP); Masaya KONDO, Tokyo (JP); Misaki SHIMIZU, Tokyo (JP); Kuni ENDO, Tokyo (JP); Yusuke KAJIO, Tokyo (JP)

(73) Assignee: SONY GROUP CORPORATION, Tokyo (JP)

(21) Appl. No.: 18/043,668

(22) PCT Filed: Sep. 8, 2021
(86) PCT No.: PCT/JP2021/033027

§ 371 Date: Mar. 1, 2023

(30) Foreign Application Priority Data
Sep. 11, 2020 (JP) 2020-153256

(51) Int. Cl. G02B 26/08; B23K 26/042

(52) U.S. Cl. CPC G02B 26/0816; B23K 26/042

(57) ABSTRACT

Provided is a light source system capable of easily performing optical axis adjustment between units. The light source system includes a second unit that detects an optical axis and performs at least one of adjustment or monitoring of a laser beam, and a third unit that performs optical axis adjustment. The third unit is configured to be able to be placed on the light incident side of the second unit, and a control device controls the optical axis adjustment of the third unit on the basis of the detection result of the optical axis.

### TECHNICAL FIELD

The present disclosure relates to a light source system, a unit, and a laser apparatus.

### BACKGROUND ART

Laser apparatuses such as a laser processing apparatus and an inspection apparatus are used in various fields. The specifications of the laser processing apparatus vary depending on the type of processing such as welding, cutting, drilling, and marking, the material of an object to be processed, and the like. Furthermore, the specifications of the inspection apparatus vary depending on the type of an inspection target and the like. Therefore, a conventional laser apparatus is made from scratch. Therefore, the conventional laser apparatus usually does not have versatility.

Therefore, in order to solve the problem described above, a laser apparatus capable of replacing units constituting a system has been proposed (see, for example, Patent Document 1).

### CITATION LIST

### Patent Document

Patent Document 1: Japanese Patent Application Laid-Open No. 2017-42820

### SUMMARY OF THE INVENTION

### Problems to be Solved by the Invention

However, in the conventional laser apparatus, since optical axis adjustment between units requires a technique of a skilled person, it is difficult to perform optical axis adjustment between units on the user side.

An object of the present disclosure is to provide a light source system, a unit, and a laser apparatus capable of easily performing optical axis adjustment between units.

### Solutions to Problems

In order to solve the above-described problem, a first disclosure provides a light source system including:
a light source module including a plurality of units configured to be able to be rearranged; and
a control device that controls the light source module,
the plurality of units including:
a first unit that oscillates a laser beam;
a second unit that detects an optical axis and performs at least one of adjustment or monitoring of a laser beam;
a third unit that performs optical axis adjustment,
the third unit configured to be able to be placed on a light incident side of the second unit, and
the control device controlling the optical axis adjustment of the third unit on the basis of a detection result of the optical axis.

A second disclosure is a laser apparatus including the light source system of the first disclosure.

A third disclosure is a unit including:
a unit configured to be able to be rearranged, the unit being used in a light source module, the unit including:
a detection section that detects an optical axis; and
a functional section that adjusts or monitors a laser beam.

A fourth disclosure is a unit configured to be able to be rearranged, the unit being used in a light source module, the unit including:
a first mirror and a second mirror that are placed to face each other;
a third mirror and a fourth mirror that are placed to face each other;
a first drive section and a second drive section that rotatably support the first mirror and the second mirror, respectively, with a first axis parallel to a perpendicular of a placement surface for the unit as a rotation axis; and
a third drive section and a fourth drive section that rotatably support the third mirror and the fourth mirror, respectively, with a second axis vertical to the first axis as a rotation axis.

### BRIEF DESCRIPTION OF DRAWINGS

FIG. 1 is a schematic view illustrating an example of the configuration of a laser processing apparatus according to a first embodiment of the present disclosure.

FIG. 2 is a block diagram illustrating an example of the configuration of a light source system.

FIG. 3 is a block diagram illustrating an example of the configuration of a light source module.

FIG. 4 is a schematic view illustrating an example of the configuration of a functional unit and an optical axis adjustment unit.

FIG. 5A is a perspective view for explaining an example of movement of mirrors. FIG. 5B is a diagram for explaining a method of angle correction and position correction using the mirrors illustrated in FIG. 5A.

FIG. 6 is a flowchart for explaining an example of a method of correcting an optical axis of the light source system.

FIG. 7A is a perspective view illustrating a first example of a shape of a unit. FIG. 7B is a perspective view illustrating a second example of the shape of the unit. FIG. 7C is a perspective view illustrating a third example of the shape of the unit.

FIG. 8A is an exploded perspective view illustrating an example of a placement mode of the units. FIG. 8B is a perspective view illustrating an example of the placement mode of the units.

FIG. 9A is a perspective view illustrating an example of the configuration of a light source module according to a second embodiment. FIG. 9B is a cross-sectional view taken along line IXB-IXB in FIG. 9A.

FIG. 10 is an exploded perspective view illustrating an example of the configuration of the light source module according to the second embodiment.

FIG. 11 is a perspective view illustrating an example of the configuration of a light source module according to a modification.

FIG. 12A is a schematic view illustrating a first configuration example of a positioning mechanism section. FIG. 12B is a schematic view illustrating a second configuration example of the positioning mechanism section. FIG. 12C is a schematic view illustrating a third configuration example of the positioning mechanism section.

FIG. 13A is a schematic view illustrating the first configuration example of the positioning mechanism section. FIG. 13B is a schematic view illustrating the second configuration example of the positioning mechanism section. FIG. 13C is a schematic view illustrating the third configuration example of the positioning mechanism section.

FIG. 14 is a schematic view illustrating an example of the configuration of a detection section according to a modification.

FIG. 15A is a perspective view illustrating a first configuration example of a light source module according to a modification. FIG. 15B is a perspective view illustrating a second configuration example of a light source module according to a modification.

### MODE FOR CARRYING OUT THE INVENTION

Embodiments of the present disclosure will be described in the following order. Note that in all the drawings of the following embodiments, the same or corresponding parts are denoted by the same reference signs.
1. First Embodiment
1.1 Configuration of laser processing apparatus
1.2 Method of correcting optical axis
1.3 Operation and effect
2. Second Embodiment
2.1 Configuration of laser processing apparatus
2.2 Operation and effect
3. Modifications

### 1. First Embodiment

[1.1 Configuration of Laser Processing Apparatus]

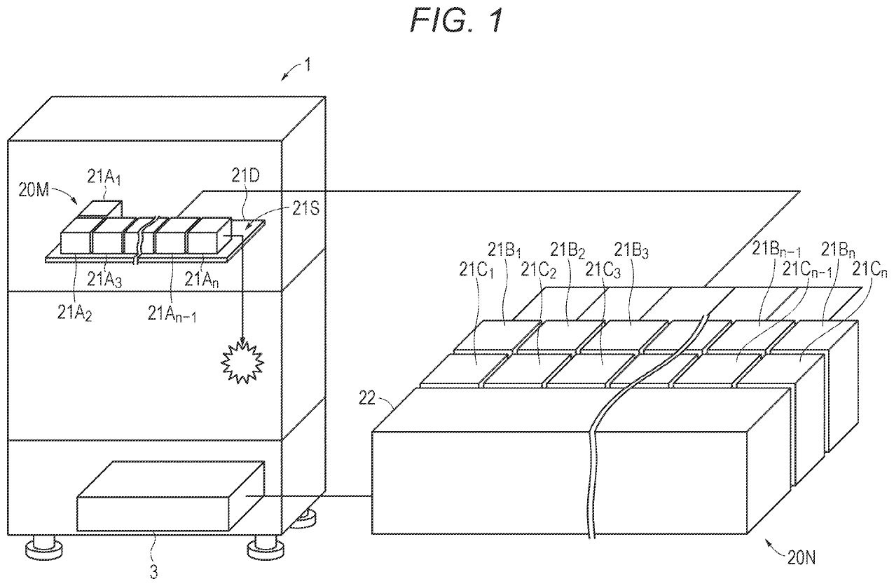

FIG. 1 is a schematic view illustrating an example of the configuration of a laser processing apparatus 1 according to a first embodiment of the present disclosure. The laser processing apparatus 1 can cope with various processing applications, and includes a light source module 20M, a control device 20N, and an apparatus-side controller 3.

(Light Source System)

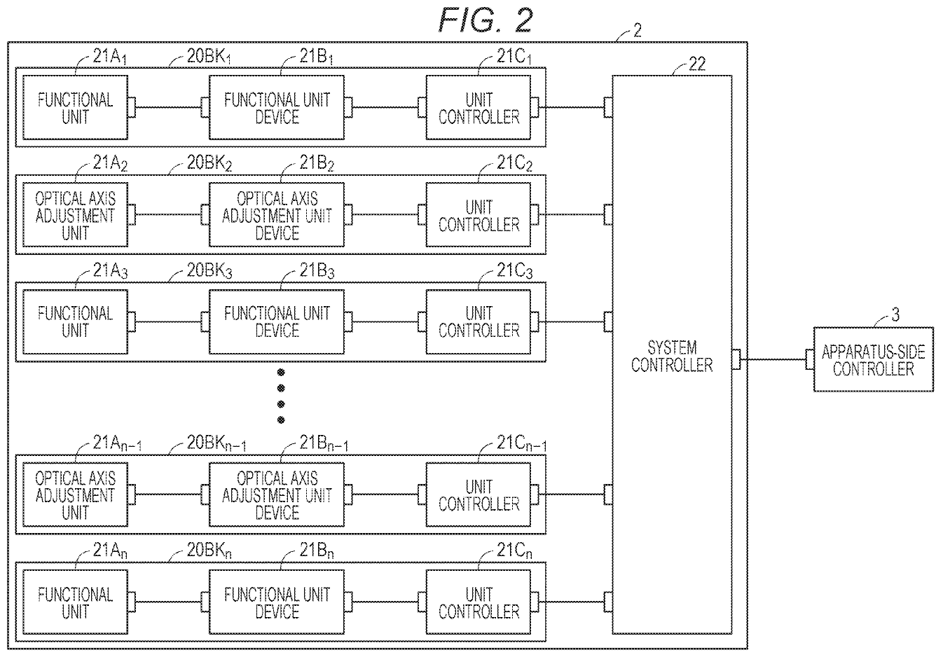

FIG. 2 is a block diagram illustrating an example of the configuration of a light source system 2. The light source system 2 includes the light source module 20M and the control device 20N.

(Light Source Module)

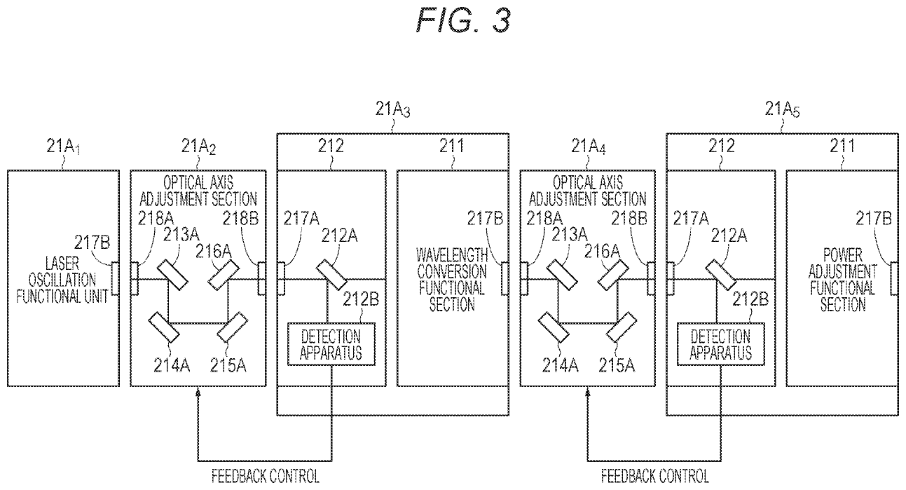

FIG. 3 is a block diagram illustrating an example of the configuration of the light source module 20M. The light source module 20M includes a plurality of functional units 21A₁, 21A₃, . . . , and 21Aₙ, a plurality of optical axis adjustment units 21A₂, 21A₄, . . . , and 21Aₙ₋₁, and a base 21D. Here, n is an odd number of 3 or more or 5 or more.

In the following description, the functional units 21A₁, 21A₃, . . . , and 21Aₙ and the optical axis adjustment units 21A₂, 21A₄, . . . , and 21Aₙ₋₁ are collectively referred to as units 21A in the case of not particularly distinguishing them from one another.

The plurality of units 21A is configured to be rearranged on the base 21D. In a state where the plurality of units 21A is placed on the base 21D, the optical axes of the adjacent units 21A are coupled. The optical axis positions on the light incident side, the optical axis positions on the light emitting side, and the optical axis height of the plurality of units 21A are unified. Furthermore, the placement locations of the plurality of units 21A on the base 21D may be specified in advance.

The plurality of units 21A is arranged in series such that the functional unit 21Aₙ and the optical axis adjustment unit 21Aₙ₋₁ alternate. The functional unit 21A₁ is placed at one end of arrangement, and the functional unit 21Aₙ is placed at the other end of the arrangement. The optical axis adjustment units 21A₂, 21A₄, . . . , and 21Aₙ₋₁ are arranged on the light incident sides of the functional units 21A₃, . . . , and 21Aₙ, respectively, except the functional unit 21A₁.

The functional unit 21A₁ is an example of a first unit, and the functional units 21A₃ 21A₅, . . . , and 21Aₙ are examples of a second unit. The optical axis adjustment units 21A₂, 21A₄, . . . , and 21Aₙ₋₁ are examples of a third unit.

(Functional Unit)

The functional unit 21A₁ is configured to be able to be placed on the light incident side of the optical axis adjustment unit 21A₂. The functional unit 21A₁ includes a laser oscillator that oscillates a laser beam of a specified wavelength with which a workpiece is irradiated.

Each of the functional units 21A₃, 21A₅, . . . , and 21Aₙ detects an optical axis and performs at least one of adjustment or monitoring of the laser beam oscillated by the functional unit 21A₁. The functional units 21A₃, 21A₅, . . . , and 21Aₙ are configured to be able to be placed on the light emitting sides of the optical axis adjustment units 21A₂, 21A₄, and 21Aₙ₋₁, respectively. An optical component of each of the functional units 21A₃, 21A₅, . . . , and 21Aₙ may be adjusted on the basis of a reference axis determined in advance.

Each of the functional units 21A₃, 21A₅, . . . , and 21Aₙ includes a functional section 211 and a detection section 212. The functional section 211 is provided on the light emitting side in each of the functional units 21A₃, 21A₅, . . . , and 21Aₙ. The functional section 211 performs at least one of adjustment or monitoring of the laser beam oscillated by the functional unit 21A₁. The functional sections 211 of the functional units 21A₃, 21A₅, . . . , 21Aₙ may have different functions. The functional section 211 may include, for example, at least one of an amplifier, a power adjustment section, a wavelength conversion section, a shutter, a light flux diameter changing section, a polarization state changing section, a branching section, an optical axis height changing section, an optical axis direction changing section, or a laser profile monitoring section, or may include any one of them. As a result, the functional units 21A₃, 21A₅, . . . , and 21Aₙ can be freely selected on the user side according to requirements and specifications.

The amplifier amplifies and outputs an input laser beam. The power adjustment section adjusts and outputs power of the input laser beam. A shutter section blocks an optical path of the input laser beam. The light flux diameter changing section changes the light flux diameter of the input laser beam and outputs the changed light flux diameter. The light flux diameter changing section is, for example, a beam expander.

The polarization state changing section changes the polarization state by using a polarizing element. The branching section branches the input laser beam and outputs the branched input laser beam. The optical axis height changing section changes the optical axis height of the input laser beam. The optical axis direction changing section changes the optical axis direction of the light source module 20M. For example, the direction of the optical axis of the light source module 20M is changed from the horizontal direction to the vertical direction or from the vertical direction to the horizontal direction. The laser profile monitoring section monitors the profile of the input laser beam and outputs the profile to the control device 20N.

The detection section 212 is provided on the light incident side in each of the functional units 21A₃, 21A₅, . . . , and 21Aₙ. The detection section 212 detects the angle and the shift amount of an optical axis, and outputs the detection result to the control device 20N. The detection section 212 includes a mirror 212A and a detection apparatus 212B. The mirror 212A is, for example, a one-way mirror, and reflects part of the laser beam incident on the functional unit 21A to cause the part of the laser beam to be incident on the detection apparatus 212B, and transmits the rest of the laser beam to cause the rest of the laser beam to be incident on the functional section 211.

The detection apparatus 212B detects the angle and the shift amount of the optical axis on the basis of the laser beam incident from the mirror 212A, and outputs the detection result to the control device 20N.

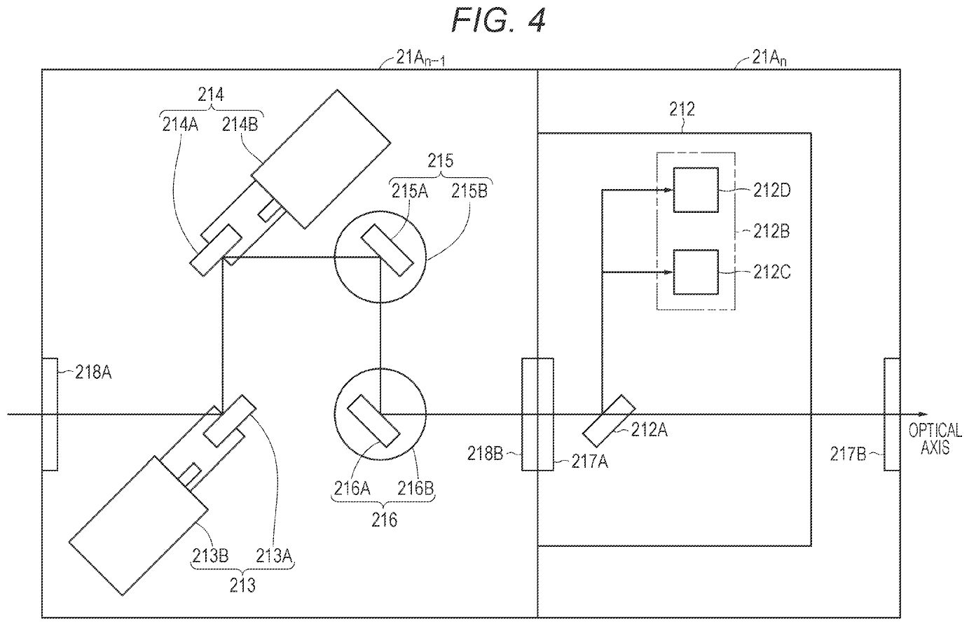

As illustrated in FIG. 4, the detection apparatus 212B includes a light receiving element 212C configured to detect a position and a light receiving element 212D configured to detect an angle. Note that in FIG. 4, illustration of the functional section 211 is omitted. The light receiving element 212C configured to detect a position detects the shift amount of the optical axis. The light receiving element 212D configured to detect an angle detects the angle of the optical axis of the laser beam incident on the functional unit 21A. Each of the light receiving element 212C and the light receiving element 212D includes, for example, a complementary metal oxide semiconductor (CMOS), a charge coupled device (CCD), a position sensitive device (PSD), or the like.

The functional unit 21A₁ further includes a window (second window) 217B. Each of the functional units 21A₃, 21A₅, . . . , and 21Aₙ further includes a window (first window) 217A and the window (second window) 217B. The window 217A is provided on the light incident side of each of the functional units 21A₃, 21A₅, . . . , and 21Aₙ. A laser beam enters each of the functional units 21A₃, 21A₅, . . . , and 21Aₙ through the window 217A. The window 217B is provided on the light emitting side of each of the functional units 21A₃, 21A₅, . . . , and 21Aₙ. A laser beam is emitted from each of the functional units 21A₃, 21A₅, . . . , and 21Aₙ through the window 217B.

As described above, since the functional unit 21A₁ includes the window 217A, the functional unit 21A₁ can have a dustproof sealed structure in which dust does not get. Furthermore, since each of the functional units 21A₃, 21A₅, . . . , and 21Aₙ includes the window 217A and the window 217B, the functional units 21A₃, 21A₅, . . . , and 21Aₙ can have a dustproof sealed structure in which dust does not get. Therefore, during use or storage of the functional units 21A₁, 21A₃ . . . , and 21Aₙ, dust adhesion to optical components inside the functional units 21A₁, 21A₃ . . . , and 21Aₙ can be suppressed. Therefore, a maintenance time of the functional units 21A₁, 21A₃ . . . , and 21Aₙ can be shortened. Furthermore, it is possible to prolong the life of the optical components inside the functional units 21A₁, 21A₃ . . . , and 21Aₙ.

(Optical Axis Adjustment Unit)

The optical axis adjustment units 21A₂, 21A₄, . . . , and 21Aₙ₋₁ are configured to be able to be placed on the light incident sides of the functional units 21A₃, 21A₅, . . . , and 21Aₙ, respectively. Each of the optical axis adjustment units 21A₂, 21A₄, . . . , and 21Aₙ₋₁ performs optical axis adjustment under the control of the control device 20N. That is, each of the optical axis adjustment units 21A₂, 21A₄, . . . , and 21Aₙ₋₁ corrects optical axis deviation under the control of the control device 20N. More specifically, the deviation of the angle (tilt amount) of the optical axis and the deviation (shift amount) of the position of the optical axis are corrected. Each of the optical components included in the optical axis adjustment units 21A₂, 21A₄, . . . , and 21Aₙ₋₁ may be adjusted on the basis of a reference axis determined in advance.

As illustrated in FIG. 4, the optical axis adjustment unit 21Aₙ₋₁ includes four optical axis adjustment sections 213, 214, 215, and 216. The optical axis adjustment section 213 includes a mirror 213A and a drive section 213B. The optical axis adjustment section 214 includes a mirror 214A and a drive section 214B. The optical axis adjustment section 215 includes a mirror 215A and a drive section 215B. The optical axis adjustment section 216 includes a mirror 216A and a drive section 216B.

The mirror 213A and the mirror 214A are placed such that their reflective surfaces face each other. The mirror 215A and the mirror 216A are placed such that their reflective surfaces face each other. The mirror 213A reflects the laser beam incident on the optical axis adjustment unit 21Aₙ₋₁ toward the mirror 214A. The mirror 214A reflects the incident laser beam toward the mirror 215A. The mirror 215A reflects the incident laser beam toward the mirror 216A. The mirror 216A emits the incident laser beam toward the functional unit 21Aₙ. The drive sections 213B, 214B, 215B, and 216B are, for example, uniaxial motors.

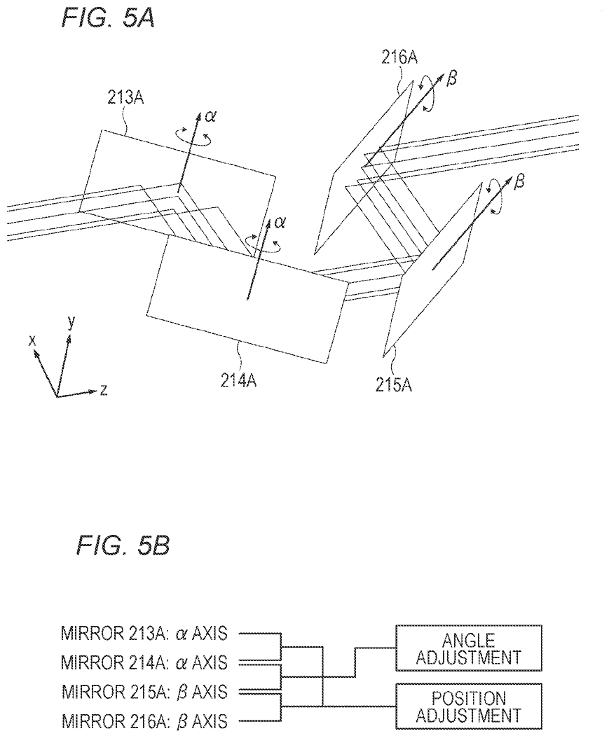

FIG. 5A is a perspective view for explaining an example of movement of the mirrors 213A, 214A, 215A, and 216A. The drive sections 213B and 214B support the mirrors 213A and 214A, respectively, so as to be rotatable about an α axis (first axis) as a rotation axis. The drive sections 215B and 216B rotatably support the mirrors 215A and 216A, respectively, with a β axis (second axis) as a rotation axis. The α axis is an axis vertical to a placement surface 21S of the base 21D. The β axis is an axis horizontal to the placement surface 21S of the base 21D. That is, the β axis is an axis vertical to the α axis.

Note that in the present Description, a direction orthogonal to both the perpendicular of the placement surface 21S of the base 21D and the specified optical axis of the light source module 20M is referred to as an x-axis direction, a direction of the perpendicular of the placement surface 21S of the base 21D is referred to as a y-axis direction, and a direction of the specified optical axis of the light source module 20M is referred to as a z-axis direction. Furthermore, the angle of the optical axis in the xz plane (plane including the x axis and the z axis) with respect to the specified optical axis of the light source module 20M is referred to as angle θₓ, and an angle of the optical axis in the yz plane (plane including the y axis and the z axis) with respect to the specified optical axis of the light source module 20M is referred to as angle θ_{y}. Furthermore, the shift amount in the x-axis direction with respect to the reference optical axis of the light source module 20M is referred to as shift amount Sₓ, and the shift amount in the y-axis direction with respect to the reference optical axis of the light source module 20M is referred to as shift amount S_{y}. Note that the position and the specified angle of the specified optical axis of the light source module 20M are stored in advance in a storage section of each of unit controllers 21C₂, 21C₄, . . . , and 21Cₙ of the optical axis adjustment units 21A₂, 21A₄, . . . , and 21Aₙ₋₁.

FIG. 5B is a diagram for explaining a method of angle correction and position correction using the mirrors 213A, 214A, 215A, and 216A. The control device 20N can perform position correction of the angle θₓ of the optical axis and the angle θ_{y} of the optical axis by rotating the mirror 214A about the α axis as the rotation axis and rotating the mirror 215A about the β axis as the rotation axis on the basis of the detection result of the angle of the optical axis.

The control device 20N can correct the shift amount Sₓ of the optical axis by rotating the mirrors 213A and 214A facing each other in synchronization with the α axis as the rotation axis on the basis of the detection result of the position of the optical axis. Furthermore, the control device 20N can correct the shift amount S_{y} of the optical axis by rotating the mirrors 215A and 215A facing each other in synchronization with the β axis as the rotation axis on the basis of the detection result of the position of the optical axis.

Each of the optical axis adjustment units 21A₂, 21A₄, . . . , and 21Aₙ₋₁ further includes a window (first window) 218A and a window (second window) 218B. The window 218A is provided on the light incident side of each of the optical axis adjustment units 21A₂, 21A₄, . . . , and 21Aₙ₋₁. A laser beam enters each of the optical axis adjustment units 21A₂, 21A₄, . . . , and 21Aₙ₋₁ through the window 218A. The window 218B is provided on the light emitting side of each of the optical axis adjustment units 21A₂, 21A₄, . . . , and 21Aₙ₋₁. A laser beam enters each of the optical axis adjustment units 21A₂, 21A₄, . . . , and 21Aₙ₋₁ through the window 218B. As described above, since each of the optical axis adjustment units 21A₂, 21A₄, . . . , and 21Aₙ₋₁ includes the window 218A and the window 218B, it is possible to obtain similar effects as those in a case where each of the functional units 21A₃, 21A₅, . . . , and 21Aₙ includes the window 217A and the window 217B.

(Base)

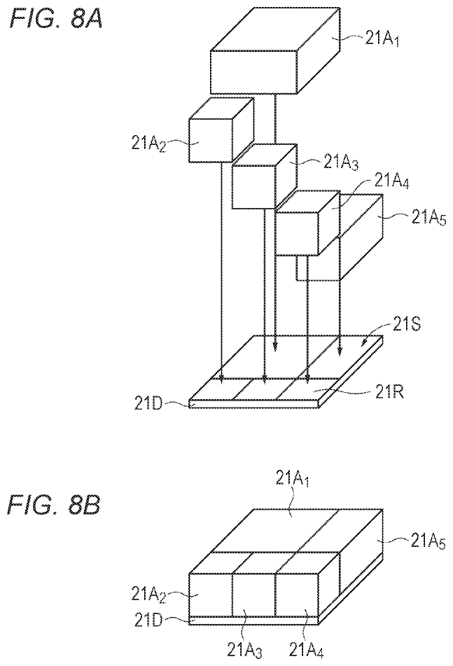

The base 21D has the placement surface 21S for placing the plurality of units 21A. The base may have a plate shape. As illustrated in FIG. 8A, the placement surface 21S is provided with a plurality of regions 21R. The plurality of units 21A is arranged in the plurality of regions 21R, respectively. The shape and area of each region 21R are standardized to correspond to the shape and footprint of the unit 21A.

(Control Device)

The control device 20N performs feedback control of the optical axis adjustment units 21A₂, 21A₄, . . . , and 21Aₙ₋₁ on the basis of the detection results of the optical axis detected by the functional units 21A₃, 21A₅, . . . , and 21Aₙ, specifically, the detection results of the angle and the shift amount of the optical axis, and therefore corrects the deviation of the optical axis (specifically, the angle and the shift amount of the optical axis).

As illustrated in FIG. 1, the control device 20N includes a plurality of functional unit devices 21B₁, 21B₃, . . . , and 21Bₙ, a plurality of optical axis adjustment unit devices 21B₂, 21B₄, . . . , and 21Bₙ₋₁, a plurality of unit controllers 21C₁, 21C₂, . . . , and 21Cₙ, and a system controller 22.

As illustrated in FIG. 2, the functional unit 21Aₙ, the functional unit device 21Bₙ, and the unit controller 21Cₙ constitute a functional block 20BKₙ. The optical axis adjustment unit 21Aₙ₋₁, the optical axis adjustment unit device 21Bₙ₋₁, and the unit controller 21Cₙ₋₁ constitute an optical axis adjustment block 20BKₙ₋₁. The functional units 21Aₙ are recombined in units of the functional blocks 20BKₙ. The optical axis adjustment units 21Aₙ₋₁ are recombined in units of the optical axis adjustment blocks 20BKₙ₋₁.

In the following description, in a case where the functional blocks 20BK₁, 21BK₃, . . . , and 21BKₙ and the optical axis adjustment blocks 20BK₂, 20BK₄, . . . , and 20BKₙ₋₁ are collectively referred to as blocks 20BK without being particularly distinguished from one another.

(Functional Unit Device)

The functional unit devices 21B₁, 21B₃, . . . , and 21Bₙ are devices such as drivers for driving and controlling the drive sections and the like in the functional units 21A₁, 21A₃, . . . , and 21Aₙ, respectively. Furthermore, the functional unit devices 21B₁, 21B₃, . . . , and 21Bₙ may include a device such as a temperature controller for temperature control.

(Optical Axis Adjustment Unit Device)

The optical axis adjustment unit devices 21B₂, 21B₄, . . . , and 21Bₙ₋₁ are devices such as drivers for driving and controlling the drive sections 213B, 214B, 215B, and 216B in the optical axis adjustment units 21A₂, 21A₄, . . . , and 21Aₙ₋₁, respectively.

(Unit Controller)

The unit controllers 21C₁, 21C₃, . . . , and 21Cₙ control the functional units 21A₁, 21A₃, . . . , and 21Aₙ via the functional unit devices 21B₁, 21B₃, . . . , and 21Bₙ, respectively, on the basis of an instruction from the system controller 22.

The unit controllers 21C₂, 21C₄, . . . , and 21Cₙ₋₁ control the optical axis adjustment units 21A₂, 21A₄, . . . , and 21Aₙ₋₁ via the optical axis adjustment unit devices 21B₂, 21B₄, . . . , and 21Bₙ₋₁, respectively, on the basis of an instruction from the system controller 22.

Each of the unit controllers 21C₁, 21C₂, . . . , and 21Cₙ includes a storage section (not illustrated). The storage sections of the unit controllers 21C₁, 21C₃, . . . , and 21Cₙ store reference axis information for adjusting the optical components of the functional units 21A₁, 21A₃, . . . , and 21Aₙ, respectively. Furthermore, the storage section of each of the unit controllers 21C₁, 21C₃, . . . , 21Cₙ stores an adjustment value obtained when the optical component is adjusted on the basis of the reference axis information described above.

The storage sections of the unit controllers 21C₂, 21C₄, . . . , and 21Cₙ₋₁ store reference axis information for adjusting the optical components (specifically, the mirrors 213A, 214A, 215A, and 216A) of the optical axis adjustment units 21A₂, 21A₄, . . . , and 21Aₙ₋₁. Furthermore, the storage section of each of the unit controllers 21C₂, 21C₄, . . . , 21Cₙ₋₁ stores an adjustment value obtained when the optical component is adjusted on the basis of the reference axis information described above.

The unit controllers 21C₁, 21C₃, . . . , and 21Cₙ adjust the optical components of the functional units 21A₁, 21A₃, . . . , and 21Aₙ via the functional unit devices 21B₁, 21B₃, . . . , and 21Bₙ, respectively, on the basis of the reference axis information stored in the storage sections, on the basis of an instruction from the system controller 22. As a result, it becomes unnecessary to take care of the optical components inside the functional units 21A₁, 21A₃, . . . , and 21Aₙ on the user side, and handling of the light source system 2 becomes easy.

The unit controllers 21C₂, 21C₄, . . . , and 21Cₙ₋₁ adjust the optical components (specifically, the optical axis adjustment sections 213, 214, 215, and 216) of the optical axis adjustment units 21A₂, 21A₄, . . . , and 21Aₙ₋₁ via the optical axis adjustment unit devices 21B₂, 21B₄, . . . , and 21Bₙ₋₁, respectively, on the basis of the reference axis information stored in the storage sections, on the basis of an instruction from the system controller 22. As a result, it becomes unnecessary to take care of the optical components inside the optical axis adjustment units 21A₂, 21A₄, . . . , and 21Aₙ₋₁ on the user side, and handling of the light source system 2 becomes easy. Note that the above-described processing of adjusting the optical components is performed, for example, in a case where an order to correct the optical axis is given by an operation section, not illustrated.

(System Controller)

The system controller 22 is a host controller of the unit controllers 21C₁, 21C₂, . . . , and 21Cₙ. The system controller 22 exchanges commands and the like with the apparatus-side controller 3, and outputs control signals to the unit controllers 21C₁, 21C₂, . . . , and 21Cₙ.

The system controller 22 cooperatively controls the plurality of functional blocks 20BK₁, 20BK₃, . . . , and 20BKₙ and the optical axis adjustment blocks 20B₂, 20B₄, . . . , and 20Bₙ₋₁. Therefore, the system controller 22 can absorb the influence of the increase or decrease in the number of the functional blocks 20BK₁, 20BK₃, . . . , and 20BKₙ and the optical axis adjustment blocks 20B₂, 20B₄, . . . , and 20Bₙ₋₁. Since the control target of the apparatus-side controller 3 is the system controller 22, it is possible to provide a command that does not make the device side aware of the functional blocks 20BK₁, 20BK₃, . . . , and 20BKₙ and the optical axis adjustment blocks 20B₂, 20B₄, . . . , and 20Bₙ₋₁.

(Apparatus-Side Controller)

The apparatus-side controller 3 exchanges commands and the like with the system controller 22, and controls the functional blocks 20BK₁, 21BK₃, . . . , and 21BKₙ and the optical axis adjustment blocks 20BK₂, 20BK₄, . . . , and 20BKₙ₋₁ via the system controller 22.

(Placement Mode of Unit)

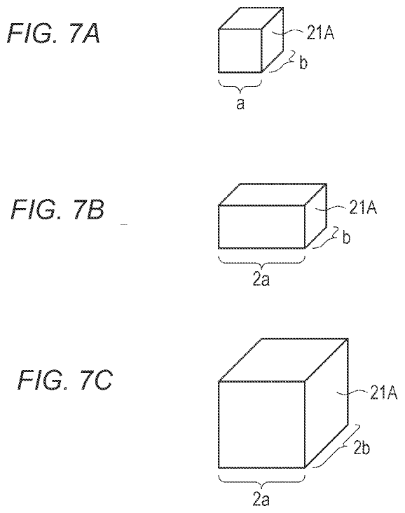

FIGS. 7A, 7B, and 7C are perspective views illustrating shape examples of the unit 21A. FIGS. 8A and 8B are perspective views illustrating an example of the placement mode of the units 21A. The shapes and footprints of the units 21A are standardized. Furthermore, the shapes and area of the regions 21R of the base 21D are standardized. As a result, the unit 21A can be easily replaced and expanded later on the user side.

The unit 21A has a cubic shape, and the base 21D has a rectangular shape. In the present Description, it is assumed that the rectangular shape includes a square shape. There is a plurality of types of footprints of the unit 21A and the area of the region 21R. The plurality of types of footprints corresponds to, for example, is equal to area of the plurality of types of regions 21R, respectively. FIGS. 7A, 7B, 7C, 8A, and 8B illustrate an example in which there are three types of footprints of the unit 21A and the area of the region 21R. The regions 21R may have a grid-like layout. Here, the footprint of the unit 21A means the occupied area of the unit 21A on the placement surface 21S of the base 21D.

The bottom surface of the unit 21A and the region 21R each have a rectangular shape. The footprint of the unit 21A is n times (here, n is an integer of 1 or more) the reference area S. Similarly, the area of the region 21R of the base 21D is n times (here, n is an integer of 1 or more) the reference area S. In the examples illustrated in FIGS. 7A, 7B, 7C, 8A, and 8B, the reference area S is a×b.

[1.2 Method of Correcting Optical Axis]

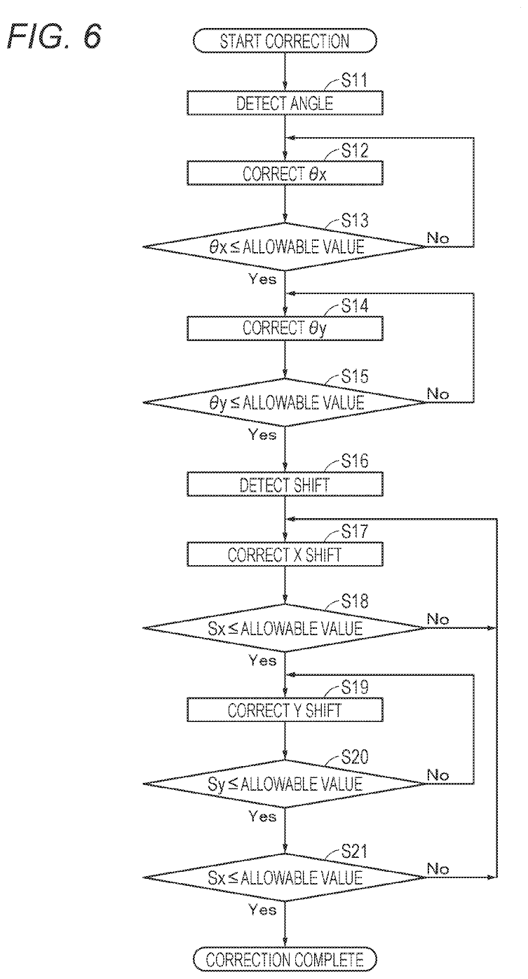

Hereinafter, an example of the method of correcting the optical axis of the light source system 2 will be described with reference to FIG. 6.

First, in step S11, the detection apparatuses 212B of the functional units 21A₃, 21A₅, . . . , and 21Aₙ detect the angles θₓ and θ_{y} of the optical axis, and output the detected angles θₓ and θ_{y} to the unit controllers 21C₂, 21C₄, . . . , and 21Cₙ₋₁, respectively.

Next, in step S12, the unit controllers 21C₂, 21C₄, . . . , and 21Cₙ₋₁ control the optical axis adjustment units 21A₂, 21A₄ . . . , and 21Aₙ₋₁ via the optical axis adjustment unit devices 21B₂, 21B₄, . . . , and 21Bₙ₋₁, respectively, on the basis of the detection result of the angle θₓ of the optical axis, and correct the angle θₓ of the optical axis. After the correction, the detection apparatuses 212B of the functional units 21A₃, 21A₅, . . . , and 21Aₙ detect the corrected angle θₓ of the optical axis, and output the corrected angle θₓ of the optical axis to the unit controllers 21C₂, 21C₄, . . . , and 21Cₙ₋₁, respectively.

Next, in step S13, the unit controllers 21C₂, 21C₄, . . . , 21Cₙ₋₁ determine whether or not the corrected angle θₓ of the optical axis falls within an allowable value. In a case where it is determined in step S13 that the angle θₓ of the optical axis falls within the allowable value, the process proceeds to step S14. In contrast, in a case where it is determined in step S13 that the angle θₓ of the optical axis does not fall within the allowable value, the process returns to step S12.

Next, in step S14, the unit controllers 21C₂, 21C₄, . . . , and 21Cₙ₋₁ control the optical axis adjustment units 21A₂, 21A₄ . . . , and 21Aₙ₋₁ via the optical axis adjustment unit devices 21B₂, 21B₄, . . . , and 21Bₙ₋₁, respectively, on the basis of the detection result of the angle θ_{y} of the optical axis, and correct the angle θ_{y} of the optical axis. After the correction, the detection apparatuses 212B of the functional units 21A₃, 21A₅, . . . , and 21Aₙ detect the corrected angle θ_{y} of the optical axis, and output the corrected angle θ_{y} of the optical axis to the unit controllers 21C₂, 21C₄, . . . , and 21Cₙ₋₁, respectively.

Next, in step S15, the unit controllers 21C₂, 21C₄, . . . , and 21Cₙ₋₁ determine whether or not the corrected angle θ_{y} of the optical axis falls within an allowable value. In a case where it is determined in step S15 that the angle θ_{y} of the optical axis falls within the allowable value, the process proceeds to step S16. In contrast, in a case where it is determined in step S15 that the angle θ_{y} of the optical axis does not fall within the allowable value, the process returns to step S14. Note that the process in steps S12 to S15 is performed by feedback control.

Next, in step S16, the detection apparatuses 212B of the functional units 21A₃, 21A₅, . . . , and 21Aₙ detect the shift amount Sₓ and the shift amount S_{y} of the optical axis, and output the shift amount Sₓ and the shift amount S_{y} to the unit controllers 21C₂, 21C₄, . . . , and 21Cₙ₋₁, respectively.

Next, in step S17, the unit controllers 21C₂, 21C₄, . . . , and 21Cₙ₋₁ control the optical axis adjustment units 21A₂, 21A₄, . . . , and 21Aₙ₋₁ via the optical axis adjustment unit devices 21B₂, 21B₄, . . . , and 21Bₙ₋₁, respectively, on the basis of the detection result of the shift amount Sₓ of the optical axis, and correct the shift amount Sₓ of the optical axis. After the correction, the detection apparatuses 212B of the functional units 21A₃, 21A₅, . . . , and 21Aₙ detect the corrected shift amount Sₓ of the optical axis, and output the corrected shift amount Sₓ of the optical axis to the unit controllers 21C₂, 21C₄, . . . , and 21Cₙ₋₁, respectively.

Next, in step S18, the unit controllers 21C₂, 21C₄, . . . , 21Cₙ₋₁ determine whether or not the corrected shift amount Sₓ of the optical axis falls within an allowable value. In a case where it is determined in step S18 that the shift amount Sₓ of the optical axis falls within the allowable value, the process proceeds to step S19. In contrast, in a case where it is determined in step S18 that the shift amount Sₓ of the optical axis does not fall within the allowable value, the process returns to step S17.

Next, in step S19, the unit controllers 21C₂, 21C₄, . . . , and 21Cₙ₋₁ control the optical axis adjustment units 21A₂, 21A₄, . . . , and 21Aₙ₋₁ via the optical axis adjustment unit devices 21B₂, 21B₄, . . . , and 21Bₙ₋₁, respectively, on the basis of the detection result of the shift amount S_{y} of the optical axis, and correct the shift amount S_{y} of the optical axis. After the correction, the detection apparatuses 212B of the functional units 21A₃, 21A₅, . . . , and 21Aₙ detect the corrected shift amount S_{y} of the optical axis, and output the corrected shift amount S_{y} of the optical axis to the unit controllers 21C₂, 21C₄, . . . , and 21Cₙ₋₁, respectively.

Next, in step S20, the unit controllers 21C₂, 21C₄, . . . , 21Cₙ₋₁ determine whether or not the corrected shift amount S_{y} of the optical axis falls within an allowable value. In a case where it is determined in step S20 that the shift amount S_{y} of the optical axis falls within the allowable value, the process proceeds to step S21. In contrast, in a case where it is determined in step S20 that the shift amount S_{y} of the optical axis does not fall within the allowable value, the process returns to step S19. Note that the process in steps S17 to S20 is performed by feedback control. Next, the detection apparatuses 212B of the functional units 21A₃, 21A₅, . . . , and 21Aₙ detect again the shift amount Sₓ of the optical axis, and output the detected shift amount Sₓ to the unit controllers 21C₂, 21C₄, . . . , and 21Cₙ₋₁, respectively.

Next, in step S21, the unit controllers 21C₂, 21C₄, . . . , 21Cₙ₋₁ determine whether or not the shift amount Sₓ of the optical axis detected again falls within the allowable value. In a case where it is determined in step S21 that the shift amount Sₓ of the optical axis falls within the allowable value, the process of correcting the optical axis ends. In contrast, in a case where it is determined in step S21 that the shift amount Sₓ of the optical axis does not fall within the allowable value, the process returns to step S17. Note that the reason why it is determined again in step S21 whether or not the shift amount Sₓ falls within the allowable value is that there is a case where the shift amount Sₓ deviates from the allowable value while the shift amount S_{y} of the optical axis is corrected in step S19.

As described above, in the method of correcting the optical axis of the light source system 2, automatic optical axis alignment can be performed with a simple configuration in which the four mirrors 213A, 214A, 215A, and 216A are combined, and by sequential operation control of correcting the angles θₓ and θ_{y} of the optical axis and then correcting the shift amounts Sₓ and S_{y} of the optical axis. Therefore, as compared with a conventional technology, high-speed and high-accuracy optical axis alignment can be performed without requiring complicated control such as global optimization. Furthermore, a control system required for system control is also simplified, and cost can be reduced in total. In addition, since an inexpensive and compact configuration in which the four mirrors 213A, 214A, 215A, and 216A are combined is adopted, a plurality of alignment mechanisms can be incorporated in an optical system, and effects such as improvement in stability of apparatus operation and improvement in manufacturability can also be obtained.

[1.3 Operation and Effect]

In the laser processing apparatus 1 according to the first embodiment, the light source module 20M is configured such that the plurality of units 21A is rearranged. Therefore, the light source module 20M can correspond to various processing applications. Furthermore, it is possible to easily switch and expand the function of the light source module 20M on the user side. In addition, the blocks 20BK can be recombined according to the type of laser processing (welding, cutting, drilling, marking, and the like), the material of the object subjected to laser processing, and the like. Therefore, it is possible to construct the laser processing apparatus 1 suitable for the type of laser processing, the material of the object subjected to laser processing, and the like in a short time. Furthermore, in a case where the light source module 20M fails, it is only necessary to replace the unit 21A in which the failure has occurred, and therefore the down time at the time of the failure can be shortened. In addition, inventory management and material procurement can be performed in units of the units 21A.

The control device 20N causes the functional units 21A₃, 21A₅, . . . , and 21Aₙ, to detect the optical axis, and performs feedback control of the optical axis adjustment units 21A₂, 21A₄, . . . , and 21Aₙ₋₁ on the basis of the detection result to automatically correct the optical axis. As a result, manual optical axis adjustment by a skilled person becomes unnecessary. Therefore, optical axis adjustment can be easily performed on the user side.

Optical axis adjustment performed by the optical axis adjustment units 21A₂, 21A₄, . . . , and 21Aₙ₋₁ uses four mirrors, corrects the angle (tilt amount) of the optical axis by two mirrors, and corrects the position (shift amount) of the optical axis by the other two mirrors. Therefore, it is possible to independently correct the angle and the position of the optical axis. Thus, it is possible to realize the light source system 2 having a simple, compact, and inexpensive structure and high stability.

In the light source system 2, each functional group is configured by a combination of the unit 21A, the unit device 21B, and the unit controller 21C. The system controller 22 is provided as a host controller of each unit controller 21C. As a result, it is possible to easily cope with an increase and a decrease in the number of units 21A.

Furthermore, the unit 21A is controlled by the unit controller 21C. Therefore, since the apparatus-side controller 3 does not need to directly control each unit 21A, control of the apparatus-side controller 3 can be simplified.

In a conventional laser processing apparatus (for example, see Patent Document 1), there is a problem that a degree of freedom in layout and switching and extension of functions are limited. In contrast, in the laser processing apparatus 1 according to the first embodiment, since the footprint of the unit is standardized, the degree of freedom in layout is improved. Furthermore, switching and expansion of functions are easy.

### 2. Second Embodiment

[2.1 Configuration of Laser Processing Apparatus]

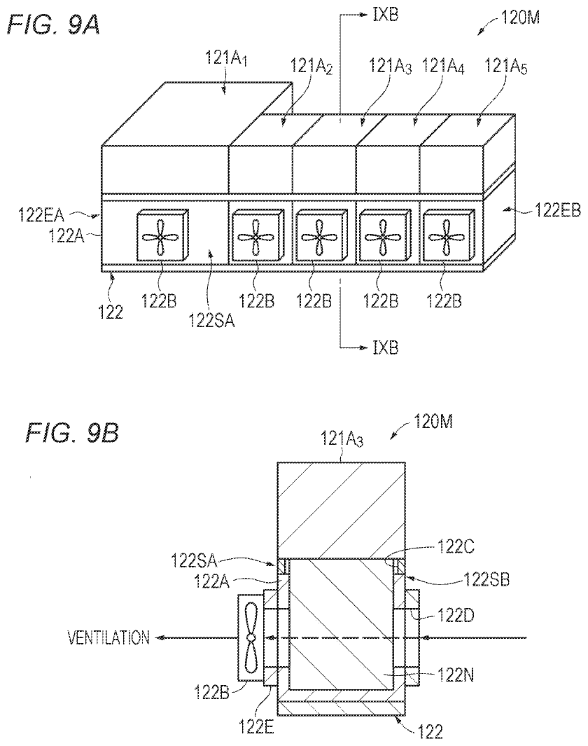

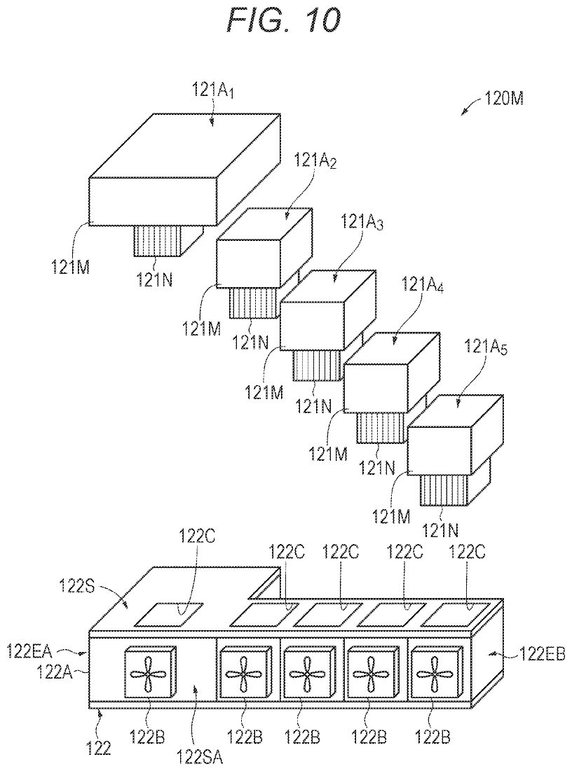

A laser processing apparatus according to a second embodiment is different from the laser processing apparatus 1 according to the first embodiment in including a light source module 120M illustrated in FIGS. 9A, 9B, and 10 in lieu of the light source module 20M illustrated in FIGS. 1, 8A, and 8B.

(Light Source Module)

The light source module 120M has an air-cooling exhaust heat structure. The light source module 120M includes a plurality of units 121A₁, 121A₂, 121A₃, 121A₄, and 121A₅, and a base 122. In the following description, the units 121A₁, 121A₂, 121A₃, 121A₄, and 121A₅ are collectively referred to as units 121A in the case of not particularly distinguishing them from one another. Here, an example in which the number of units 121A is five will be described; however, the number of units 121A is not limited thereto, and may be any number of three or more, for example.

(Unit)

The plurality of units 121A is configured to be able to be rearranged on the base 122.

The plurality of units 121A is configured to be able to be arranged in one row. The unit 121A includes a unit main body 121M, a thermal interface material (TIM) (not illustrated), and a heat sink 121N. Here, an example in which all the units 121A include the heat sink 121N will be described; however, only some of the units 121A may include the heat sink 121N.

The unit main bodies 121M of the units 121A₁, 121A₃, and 121A₅ have similar configurations as those of the functional units 21A₁, 21A₃, and 21A₅ in the above-described embodiment. The unit main bodies 121M of the units 121A₂ and 121A₄ have similar configurations as those of the optical axis adjustment units 21A₂ and 21A₄ in the above-described embodiment.

The heat sink 121N is provided on the bottom surface of the unit main body 121M. The bottom surface of the unit main body 121M is a surface placed on the base 122. The heat sink 121N absorbs heat generated in the unit main body 121M and dissipates the heat to the base 122.

The thermal interface material is provided between the unit main body 121M and the heat sink 121N. The thermal interface material efficiently increases heat conduction from the unit main body 121M to the heat sink 121N.

(Base)

The base 122 has a placement surface 122S for placing the plurality of units 121A. The placement surface 122S is provided with a plurality of hole sections 122C. The hole section 122C is configured such that the heat sink 122N of the unit 121A can be inserted thereto and removed therefrom.

The base 122 includes a duct 122A and a plurality of fans 122B. Heat generated in the unit 121A is discharged to the duct 122A via the heat sink 122N. The duct 122A has a pair of side wall sections 122SA and 122SB facing each other and a pair of end sections 122EA and 122EB facing each other. Each of the side wall sections 122SA and 122SB has an elongated shape. The end section 122EA is provided between one ends of the side wall sections 122SA and 122SB. The end section 122EB is provided between the other ends of the side wall sections 122SA and 122SB. A direction from the end section 122EA toward the end section 122EB is an arrangement direction (that is, an optical axis direction) of the plurality of units 121A. The duct 122A is connected to the plurality of hole sections 122C provided in the placement surface 122S.

In a state where the heat sink 121N is inserted into the hole section 122C, the heat sink 121N is housed in the duct 122A. The duct 122A may include a plurality of partition plates (not illustrated), and each partition plate may spatially separate the heat sinks 122N adjacent to each other in the duct 122A. The duct 122A has a plurality of opening sections 122D in the side wall section 122SB. The opening section 122D connects the space in the duct 122A to the outside.

The plurality of fans 122B is provided on the side wall section 122SA of the duct 122A. The fan 122B discharges heat discharged into the duct 122A via the heat sink 122N to the outside. The fan 122B faces the opening section 122D. Since the fan 122B is provided at such a location, if the fan 122B is driven, air flows from the opening section 122D toward the fan 122B (from one side wall section 122SA to the other side wall section 122SB). The heat sink 121N is located between the fan 122B and the opening section 122D.

The base 122 may further include an elastic body 122E between the duct 122A and the fan 122B. In this case, it is possible to suppress vibration of the light source module 120M due to driving of the fan 122B.

[2.2 Operation and Effect]

In the laser processing apparatus according to the second embodiment, the heat sink 122N allows heat generated in each unit 121A to be released into the duct 122A of the base 122. The fan 122B allows the heat released into the duct 122A to be discharged to the outside. Therefore, heat generated in the plurality of units 121A can be efficiently discharged to the outside.

### 3. Modifications

(Modification 1)

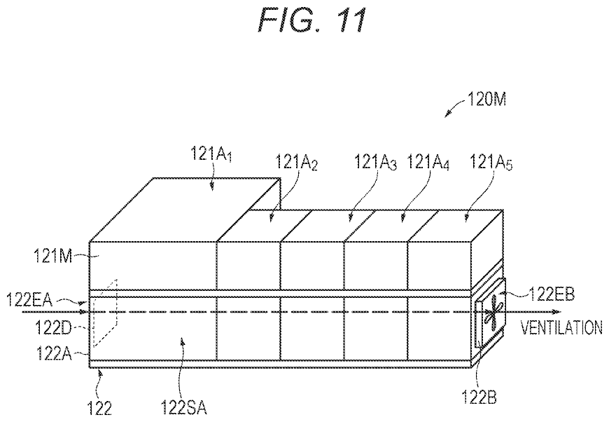

In the second embodiment, an example has been described in which the plurality of fans 122B and the plurality of opening sections 122D are provided in the side wall section 122SA and the side wall section 122SB, respectively. However, the number of fans 122B and opening sections 122D and the locations where the fans 122B and the opening sections 122D are provided are not limited to this example. For example, as illustrated in FIG. 11, the fan 122B and the opening section 122D may be provided at the end sections 122EA and 122EB, respectively. In this case, if the fan 122B is driven, air flows from the one end section 122EA toward the other end section 122EB.

(Modification 2)

In the second embodiment, an example in which the duct 122A has the plurality of opening sections 122D in the side wall section 122SB has been described. However, the duct 122A may include a plurality of fans for drawing air into the duct in lieu of the plurality of opening sections 122D.

(Modification 3)

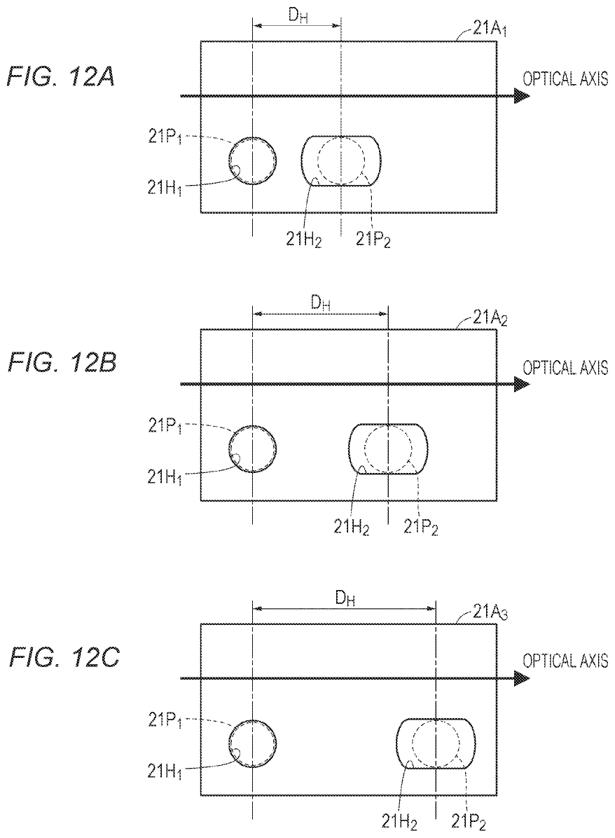

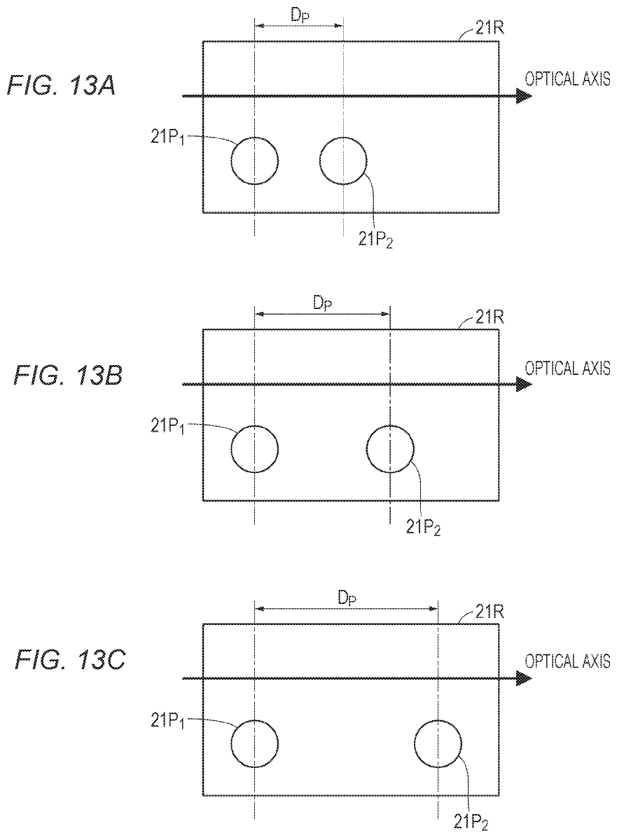

As illustrated in FIGS. 12A and 13A, the light source module 20M may include a plurality of positioning mechanism sections. The positioning mechanism section is for positioning the unit 21A on the base 21D. Note that FIGS. 12A and 13A illustrate an example of the positioning mechanism of the functional unit 21A₁.

Each positioning mechanism section includes pins 21P₁ and 21P₂ and holes 21H₁ and 21H₂. The pins 21P₁ and 21P₂ are provided in each region 21R of the base 21D. The positioning pins 21P₁ and 21P₂ protrude from the placement surface 21S of the base 21D. The holes 21H₁ and 21H₂ are provided in the bottom surface of each unit 21A. The unit 21A is positioned by fitting or abutting the pins 21P₁ and 21P₂ to the holes 21H₁ and 21H₂. Note that the pins 21P₁ and 21P₂ may be provided on the bottom surface of each unit 21A, and the holes 21H₁ and 21H₂ may be provided in each region 21R. There may be a gap between the pin 21P₁ and the hole 21H₁ and between the pin 21P₂ and the hole 21H₂ so that the unit 21A can be easily attached and detached. A clearance fit is suitable for tolerances between the pin 21P₁ and the hole 21H₁ and between the pin 21P₂ and the hole 21H₂.

Since the unit 21A and the base 21D include the positioning mechanism as described above, the unit 21A can be fixed at a specified location on the base 21D by fitting or abutting the holes 21H₁ and 21H₂ of each unit 21A to the pins 21P₁ and 21P₂ of each region 21R. Therefore, coarse adjustment of the optical axis between the units 21A can be performed.

Furthermore, since the functional unit 21An and the optical axis adjustment unit 21An−1 on the light incident side of the functional unit 21An are provided, and the functional unit 21An includes the detection apparatus 212B, the unit controller 21Cₙ₋₁ can perform feedback control of the optical axis adjustment sections 213 to 216 in the optical axis adjustment unit 21Aₙ₋₁ on the basis of the detection result of the detection apparatus 212B. Therefore, fine adjustment of the optical axis between the units 21A can be performed.

By adjusting the optical axis between the units 21A in two stages of coarse adjustment and fine adjustment, it is possible to efficiently correct the optical axis deviation between the units 21A generated when the unit 21A are placed on the base 21D. Furthermore, the work load of the user required for adjustment of the light source module 20M can be reduced.

(Modification 4)

As illustrated in FIGS. 12A, 12B, 12C, 13A, 13B, and 13C, the light source module 20M may have positioning mechanism sections different for each unit 21A (that is, for each region 21R). Note that FIGS. 12A, 12B, 12C, 13A, 13B, and 13C illustrate an example of the positioning mechanisms of the functional unit 21A₁, the optical axis adjustment unit 21A₂, and the functional unit 21A₃.

As illustrated in FIGS. 12A, 12B, and 12C, the hole 21H₁ is provided at the same location in the bottom surface of the unit 21A in all the units 21A. In contrast, the hole 2121H₂ is provided at a location in the bottom surface different for each unit 21A. The holes 21H₁ and 21H₂ are provided on a straight line parallel to the arrangement direction (optical axis direction) of the units 21A. A distance DH between the hole 21H₁ and the hole 21H₂ is different for each unit 21A.

As illustrated in FIGS. 13A, 13B, and 13C, the pin 21P₁ is provided at the same location in the region 21R in all the regions 21R. In contrast, the pin 21P₂ is provided at a location different for each region 21R. The pins 21P₁ and 21P₂ are provided on a straight line parallel to the arrangement direction (optical axis direction) of the units 21A. A distance D_{P} between the pin 21P₁ and the pin 21P₂ is different for each region 21R.

Since the light source module 20M includes the positioning mechanism sections having the above-described configuration, the unit 21A can be prevented from being erroneously placed in the direction opposite to the prescribed direction. Furthermore, the unit 21A can be prevented from being placed in a wrong region 21R.

Note that the light source module 20M may have positioning mechanism sections different for each of the functional units 21A₁, 21A₃, . . . , and 21Aₙ, and may have the same positioning mechanism sections in all the optical axis adjustment units 21A₂, 21A₄, . . . , and 21Aₙ₋₁.

Furthermore, the base 21D may be configured to be able to change the position of the pin 21P₂, that is, the distance D_{P} between the pin 21P₁ and the pin 21P₂.

(Modification 5)

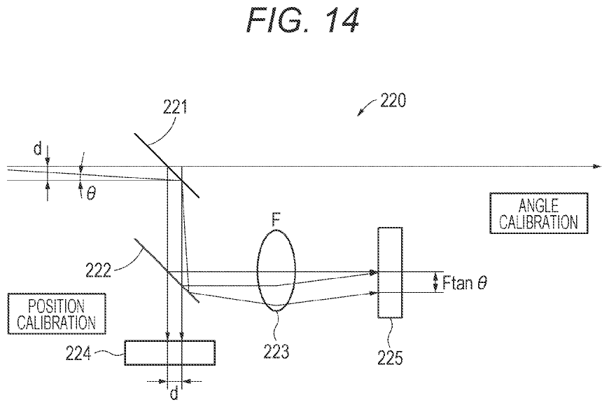

In the first and second embodiments, each of the functional units 21A₃, 21A₅, . . . , 21Aₙ may include a detection section 220 illustrated in FIG. 14 in lieu of the detection section 212 illustrated in FIG. 4. The detection section 220 includes a mirror 221, a mirror 222, a lens 223, a light receiving element 224 configured to detect a position, and a light receiving element 225 configured to detect an angle.

The mirror 221 is, for example, a one-way mirror, and reflects part of the laser beam incident on the functional unit 21Aₙ to cause the part of the laser beam to be incident on the mirror 222, and transmits the rest of the laser beam to cause the rest of the laser beam to be incident on the functional section 211. The mirror 222 is, for example, a one-way mirror, and reflects part of the incident laser beam to cause the part of the laser beam to be incident on the light receiving element 225 via the lens 223, and transmits the rest of the laser beam to cause the rest of the laser beam to be incident on the light receiving element 224.

The lens 223 is for converting an angle component (angle information) into a position component (position information). Each of the light receiving element 224 and the light receiving element 225 is a light receiving element (imaging element) for an image such as a CMOS or a CCD. By using such light receiving elements for an image as the light receiving element 224 and the light receiving element 225, a pulse laser can also be stably detected.

(Modification 6)

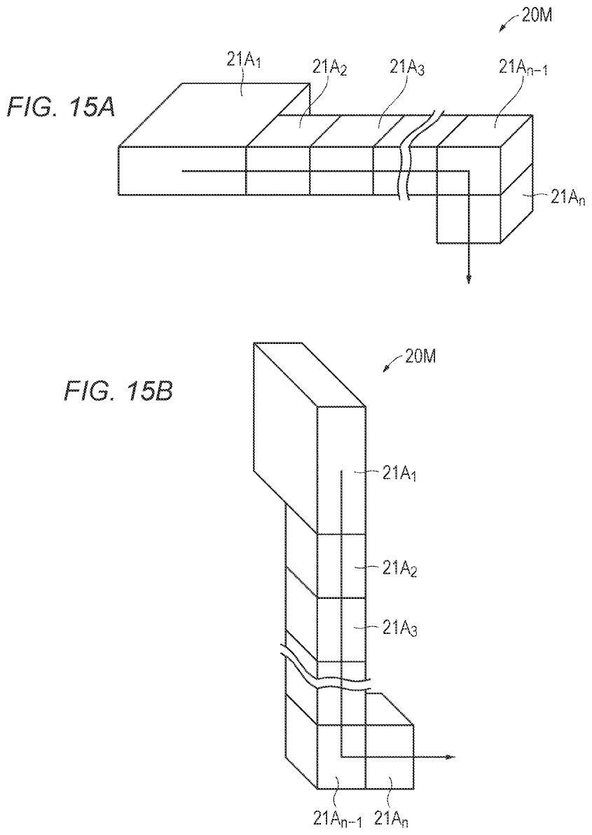

In the first and second embodiments, examples in which the plurality of units 21A is configured to be able to be arranged in the horizontal direction (first direction) has been described; however, arrangement of the plurality of units 21A is not limited thereto. For example, as illustrated in FIG. 15A, the plurality of units 21A may include at least one unit 21Aₙ₋₁ configured to be able to change the arrangement direction of the units 21A from the horizontal direction (first direction) to the vertical direction (second direction). That is, the plurality of units 21A may be configured such that the arrangement direction can be changed from the horizontal direction (first direction) to the vertical direction (second direction) in the middle of the arrangement. In this case, the unit 21Aₙ₋₁ may include an optical component such as a mirror that bends the optical axis at a right angle from the horizontal direction to the vertical direction.

As illustrated in FIG. 15B, a plurality of units 21A may include at least one unit 21Aₙ₋₁ configured to be able to change the arrangement direction of the units 21A from the vertical direction (second direction) to the horizontal direction (first direction). That is, the plurality of units 21A may be configured such that the arrangement direction can be changed from the vertical direction (second direction) to the horizontal direction (first direction) in the middle of the arrangement. In this case, the unit 21Aₙ₋₁ may include an optical component such as a mirror that bends the optical axis at a right angle from the vertical direction to the horizontal direction.

Since the light source module 20M has the above-described configuration, it is possible to improve customizability of the layout of the units 21A on the user side.

(Modification 7)

The system controller 22 may determine whether or not the plurality of units 21A is correctly arranged (laid out), and may not oscillate a laser beam in a case where it is determined that the plurality of units 21A is not correctly arranged. A specific example of such a configuration will be described below.

The unit 21A has identification information (ID) unique to each unit 21A. The unit 21A has the unique identification information as a two-dimensional code or a barcode.

The laser processing apparatus 1 includes a reader that reads the identification information. The system controller 22 includes a storage section. In this storage section, information regarding correct arrangement of the plurality of units 21A (hereinafter referred to as “correct arrangement information”) is stored. There may be a plurality of types of correct arrangement. The correct arrangement information is, for example, a table or the like in which the arrangement order of the unit 21A and the identification information of the unit 21A are associated with each other. The correct arrangement information is, for example, a table or the like in which the position information of the unit 21A on the placement surface 21S of the base 21D and the identification information of the unit 21A are associated with each other.

The user reads the identification information of the plurality of units 21A by the reader in order of arrangement (specifically, in the order in which the laser beam oscillated by the functional unit 21A₁ passes). The system controller 22 collates the identification information read in the order of the arrangement with correct arrangement information stored in advance in the storage section. In a case where it is determined as a result of the collation that the arrangement of the units 21A is correct, the system controller 22 controls the light source module 20M so that a laser beam can be oscillated. In contrast, in a case where it is determined that the arrangement of the units 21A is wrong as a result of the collation, the light source module 20M is controlled so as not to oscillate a laser beam.

A sensor (for example, a proximity sensor or the like) may be provided in the region 21R of the base 21D. In this case, the system controller 22 can determine the presence or absence of the unit 21A in the region 21R by detecting ON/OFF of the sensor.

(Modification 8)

In the first and second embodiments, examples in which the light source system 2 is applied to the laser processing apparatus 1 have been described; however, the light source system 2 may be applied to an inspection apparatus. Note that the laser processing apparatus 1 and the inspection apparatus are specific examples of the laser apparatus.

Although the first and second embodiments of the present disclosure and their modifications have been specifically described above, the present disclosure is not limited to the above-described first and second embodiments and their modifications, and various modifications based on the technical idea of the present disclosure can be made.

For example, the configurations, methods, steps, shapes, materials, numerical values, and the like described in the above-described first and second embodiments and their modifications are merely examples, and different configurations, methods, steps, shapes, materials, numerical values, and the like may be used as necessary.

Furthermore, the configurations, methods, steps, shapes, materials, numerical values, and the like of the above-described first and second embodiments and their modifications can be combined with one another without departing from the gist of the present disclosure.

In addition, the present disclosure can also be configured as follows.

(1)

A light source system including:
a light source module including a plurality of units configured to be able to be rearranged; and
a control device that controls the light source module,
a plurality of the units including:
a first unit that oscillates a laser beam;
a second unit that detects an optical axis and performs at least one of adjustment or monitoring of the laser beam; and
a third unit that performs optical axis adjustment,
the third unit configured to be able to be placed on a light incident side of the second unit, and
the control device controlling the optical axis adjustment of the third unit on the basis of a detection result of the optical axis.

(2)

The light source system according to (1),
in which the light source module further includes a base,
the base includes a plurality of regions in which a plurality of the units is arranged, respectively,
there is a plurality of types of footprints of the units,
there is a plurality of types of area of the regions, and
the plurality of types of the footprints corresponds to the plurality of types of the area of the regions, respectively.

(3)

The light source system according to (2),
in which a bottom surface of each of the units and each of the regions has a rectangular shape, and
each of the plurality of types of the footprints is n times (here, n is an integer of 1 or more) reference area.

(4)

The light source system according to any one of (1) to (3), in which optical axis positions on a light incident side, optical axis positions on a light emitting side, and optical axis heights of a plurality of the units are unified.

(5)

The light source system according to (1), in which the light source module further includes a base,
the light source module includes a plurality of positioning mechanism sections, and
a plurality of the positioning mechanism sections determines positions of the plurality of units on the base, respectively.

(6)

The light source system according to any one of (1) to (5), in which the second unit includes at least one of an amplifier, a power adjustment section, a wavelength conversion section, a shutter, a light flux diameter changing section, a polarization state changing section, a branching section, an optical axis height changing section, an optical axis direction changing section, or a laser profile monitoring section.

(7)

The light source system according to any one of (1) to (6) further including a host control apparatus that controls the control device.

(8)

The light source system according to (7), in which the host control apparatus cooperatively controls a plurality of the units via the control device.

(9)

The light source system according to any one of (1) to (8),
in which each of the units includes an optical component, and
the optical component is adjusted on the basis of a predetermined reference axis.

(10)

The light source system according to any one of (1) to (9), in which each of the second unit and the third unit includes:
a first window that is provided on a light incident side; and
a second window that is provided on a light emitting side.

(11)

The light source system according to any one of (1) to (10), in which the third unit includes:
a first mirror and a second mirror that are placed to face each other;
a third mirror and a fourth mirror that are placed to face each other;
a first drive section and a second drive section that rotatably support the first mirror and the second mirror, respectively, with a first axis parallel to a perpendicular of a placement surface for the units as a rotation axis; and
a third drive section and a fourth drive section that rotatably support the third mirror and the fourth mirror, respectively, with a second axis vertical to the first axis as a rotation axis.

(12)

The light source system according to (11),
in which the second unit detects an angle of the optical axis and a shift amount of the optical axis, and
the control device
controls the second drive section and the third drive section to rotate the second mirror and the third mirror on the basis of a detection result of the angle of the optical axis, and
controls the first drive section and the second drive section to rotate the first mirror and the second mirror in synchronization and controls the third drive section and the fourth drive section to rotate the third mirror and the fourth mirror in synchronization on the basis of a detection result of a position of the optical axis.

(13)

The light source system according to any one of (1) to (12),
in which the second unit includes:
a first light receiving element configured to detect an angle of the optical axis; and
a second light receiving element configured to detect a position of the optical axis, and
the control device controls the third unit on the basis of outputs of the first light receiving element and the second light receiving element.

(14)

The light source system according to any one of (1) to (13), in which a plurality of the units is configured to be able to change an arrangement direction from a horizontal direction to a vertical direction or from the vertical direction to the horizontal direction.

(15)

The light source system according to any one of (1) to (15), in which the control device determines whether or not arrangement of a plurality of the units is correct, and does not oscillate the laser beam in a case where the arrangement is incorrect.

(16)

The light source system according to any one of (1) to (15), in which control of the optical axis adjustment is feedback control.

(17)

The light source system according to any one of (1) to (16),
in which the light source module further includes a base,
each of the units further includes a heat sink, and
the base includes:
a duct through which heat is released from the heat sink; and
a fan that exhausts air from the duct.

(18)

A laser apparatus including the light source system according to any one of (1) to (17).

(19)

A unit configured to be able to be rearranged, the unit being used in a light source module, the unit including:
a detection section that detects an optical axis; and
a functional section that adjusts or monitors a laser beam.

(20)

A unit configured to be able to be rearranged, the unit being used in a light source module, the unit including:
a first mirror and a second mirror that are placed to face each other;
a third mirror and a fourth mirror that are placed to face each other;
a first drive section and a second drive section that rotatably support the first mirror and the second mirror, respectively, with a first axis parallel to a perpendicular of a placement surface for the unit as a rotation axis; and
a third drive section and a fourth drive section that rotatably support the third mirror and the fourth mirror, respectively, with a second axis vertical to the first axis as a rotation axis.

### REFERENCE SIGNS LIST

1 Laser processing apparatus
2 Light source system
3 Apparatus-side controller
20BK₁, 21BK₃, 21BKₙ Functional block
20BK₂, 20BK₄, 20BKₙ₋₁ Optical axis adjustment block
20M Light source module
20N Control device
21A₁, 21A₃, 21Aₙ Functional unit
21A₂, 21A₄, 21Aₙ₋₁ Optical axis adjustment unit
21B₁, 21B₃, 21Bₙ Functional unit device
21B₂, 21B₄, 21Bₙ₋₁ Optical axis adjustment unit device
21C₁, 21C₂, 21C Unit controller
21D Base
21R Region
21P₁, 21P₂ Pin
21H₁, 21H₂ Hole
22 System controller
120M Light source module
121A₁, 121A₂, 121A₃, 121A₄, 121A₅ Unit
121M Unit main body
121N Heat sink
122 Base
122A Duct
122B Fan
122C Hole section
122D Opening section
122E Elastic body
211 Functional section
212 Detection section
212A Mirror
212B Detection apparatus
212C Light receiving element configured to detect a position
212D Light receiving element configured to detect an angle
213, 214, 215, 216 Optical axis adjustment section
213A, 214A, 215A, 216A Mirror
213B, 214B, 215B, 216B, 217B Drive section
217A, 218A Window (First window)
217B, 218B Window (Second window)
220 Detection section
221, 222 Mirror
223 Lens
224 Light receiving element configured to detect a position
225 Light receiving element configured to detect an angle

What is claimed is:

1. A light source system, comprising:
a light source module including a plurality of units configured to be able to be rearranged; and
a control device that controls the light source module,
a plurality of the units including:
a first unit that oscillates a laser beam;
a second unit that detects an optical axis and performs at least one of adjustment or monitoring of the laser beam; and
a third unit that performs optical axis adjustment,
the third unit configured to be able to be placed on a light incident side of the second unit, and
the control device controlling the optical axis adjustment of the third unit on a basis of a detection result of the optical axis.

2. The light source system according to claim 1,
wherein the light source module further includes a base,
the base includes a plurality of regions in which a plurality of the units is placed, respectively,
there is a plurality of types of footprints of the units,
there is a plurality of types of area of the regions, and
the plurality of types of the footprints corresponds to the plurality of types of the area of the regions, respectively.

3. The light source system according to claim 2,
wherein a bottom surface of each of the units and each of the regions has a rectangular shape, and
each of the plurality of types of the footprints is n times (here, n is an integer of 1 or more) reference area.

4. The light source system according to claim 1, wherein optical axis positions on a light incident side, optical axis positions on a light emitting side, and optical axis heights of a plurality of the units are unified.

5. The light source system according to claim 1,
wherein the light source module further includes a base,
the light source module includes a plurality of positioning mechanism sections, and
a plurality of the positioning mechanism sections determines positions of a plurality of the units on the base, respectively.

6. The light source system according to claim 1, wherein the second unit includes at least one of an amplifier, a power adjustment section, a wavelength conversion section, a shutter, a light flux diameter changing section, a polarization state changing section, a branching section, an optical axis height changing section, an optical axis direction changing section, or a laser profile monitoring section.

7. The light source system according to claim 1 further comprising a host control apparatus that controls the control device.

8. The light source system according to claim 7, wherein the host control apparatus cooperatively controls a plurality of the units via the control device.

9. The light source system according to claim 1,
wherein each of the units includes an optical component, and
the optical component is adjusted on a basis of a predetermined reference axis.

10. The light source system according to claim 1, wherein each of the second unit and the third unit includes:
a first window that is provided on a light incident side; and
a second window that is provided on a light emitting side.

11. The light source system according to claim 1, wherein the third unit includes:
a first mirror and a second mirror that are placed to face each other;
a third mirror and a fourth mirror that are placed to face each other;
a first drive section and a second drive section that rotatably support the first mirror and the second mirror, respectively, with a first axis parallel to a perpendicular of a placement surface for the units as a rotation axis; and
a third drive section and a fourth drive section that rotatably support the third mirror and the fourth mirror, respectively, with a second axis vertical to the first axis as a rotation axis.

12. The light source system according to claim 11,
wherein the second unit detects an angle of the optical axis and a shift amount of the optical axis, and
the control device
controls the second drive section and the third drive section to rotate the second mirror and the third mirror on a basis of a detection result of the angle of the optical axis, and
controls the first drive section and the second drive section to rotate the first mirror and the second mirror in synchronization and controls the third drive section and the fourth drive section to rotate the third mirror and the fourth mirror in synchronization on a basis of a detection result of a position of the optical axis.

13. The light source system according to claim 1,
wherein the second unit includes:
a first light receiving element configured to detect an angle of the optical axis; and
a second light receiving element configured to detect a position of the optical axis, and
the control device controls the third unit on a basis of outputs of the first light receiving element and the second light receiving element.

14. The light source system according to claim 1, wherein a plurality of the units is configured to be able to change an arrangement direction from a horizontal direction to a vertical direction or from the vertical direction to the horizontal direction.

15. The light source system according to claim 1, wherein the control device determines whether or not arrangement of a plurality of the units is correct, and does not oscillate the laser beam in a case where the arrangement is incorrect.

16. The light source system according to claim 1, wherein control of the optical axis adjustment is feedback control.

17. The light source system according to claim 1,
wherein the light source module further includes a base,
each of the units further includes a heat sink, and
the base includes:
a duct through which heat is released from the heat sink; and
a fan that exhausts air from the duct.

18. A laser apparatus comprising the light source system according to claim 1.

19. A unit configured to be able to be rearranged, the unit being used in a light source module, the unit comprising:
a detection section that detects an optical axis; and
a functional section that adjusts or monitors a laser beam.

20. A unit configured to be able to be rearranged, the unit being used in a light source module, the unit comprising:
a first mirror and a second mirror that are placed to face each other;
a third mirror and a fourth mirror that are placed to face each other;
a first drive section and a second drive section that rotatably support the first mirror and the second mirror, respectively, with a first axis parallel to a perpendicular of a placement surface for the unit as a rotation axis; and
a third drive section and a fourth drive section that rotatably support the third mirror and the fourth mirror, respectively, with a second axis vertical to the first axis as a rotation axis.
